(19) United States
(12) Patent Application Publication
(10) Pub. No.: US 2025/0318555 A1
(43) Pub. Date: Oct. 16, 2025

(54) Irregular and Random Shaped Extruded Protein Puff Cereal

(71) Applicant: General Mills, Inc., Minneapolis, MN (US)

(72) Inventors: Brian A. Ernst, Watertown, MN (US); Douglas L. Goedeken, Blaine, MN (US); Jeffrey Thomas Huber, Robbinsdale, MN (US); Reed Taylor, Brooklyn Park, MN (US); Goeran Walther, Plymouth, MN (US); Scott K. Whitman, New Hope, MN (US)

(73) Assignee: General Mills, Inc., Minneapolis, MN (US)

(21) Appl. No.: 18/855,381

(22) PCT Filed: May 15, 2023
(86) PCT No.: PCT/US2023/022242

§ 371 Date: Oct. 9, 2024

Related U.S. Application Data
(60) Provisional application No. 63/342,215, filed on May 16, 2022.

(51) Int. Cl. A23L 7/17; A23J 3/14; A23J 3/16; A23J 3/26; A23L 7/122

(52) U.S. Cl. CPC A23L 7/17; A23J 3/14; A23J 3/16; A23J 3/26; A23L 7/122

(57) ABSTRACT

Puffed cereal pieces which are random and irregular in size and shape relative to each other are produced by forming a protein-based cereal dough, having a density of about 100-150 g/100 in³ and including about 30-60% plant protein by weight, in an extruder, extruding the cereal dough from a plurality of spaced, commonly shaped geometric openings of a die, directly expanding the cereal dough, cutting the cereal dough into extrudate pieces, and drying the extrudate pieces. The plant protein is derived from seeds, legumes or grains, with a particular embodiment employing a combination of soy protein isolate and one or more types of grains.

### FIELD OF THE INVENTION

The present invention relates to food products and, more particularly, to a method for making plant protein based cereal pieces, as well as the resulting cereal pieces. In particular, the present invention relates to the making of ready-to-eat randomly and distinctly sized and shaped cereal pieces by extruding, cutting and puffing plant protein containing cereal dough.

### BACKGROUND OF THE INVENTION

A wide variety of food products are prepared from cooked cereal doughs especially ready-to-eat (“RTE”) or breakfast cereals, as well as a variety of snack products. Generally, in the preparation of the cooked cereal dough, cereal or farinaceous ingredients, such as various grain-based cereal flours, are first admixed with other dry ingredients such as salt, minerals, starch, sugars, to form a dry blend of ingredients and then is further blended with various liquid ingredients, including water, sheared and heated to gelatinize or cook the starch fraction of the cereal ingredients and other starchy materials. The gelatinized or cooked mass is then worked to form homogenous or well blended cooked cereal dough. A wide variety of blending cooking, working apparatus and techniques are well known.

The preparation of a cooked cereal dough using a cooker extruder especially a single or twin screw extruder has become commonplace. The production of many food products involves the extrusion of cooked food material under pressure through a die opening of a die as an extrudate and then to cut that extrudate into lengths as it exits the die opening. A common technique for cutting the extrudate is the use of a rotary cutter which rotates multiple blades past die openings located in a pattern in the die, with the extrudate being processed to form expanded finished cereal pieces of generally uniform size and shape which are dried to form finished cereal base pieces. Thereafter, the finished dried cereal base pieces can have a topical coating applied to provide desired taste and texture attributes.

In these known cereal production processes, there is a direct correlation between the shape of the die openings and the resulting finished cereal pieces, e.g., a round die opening is used to produce generally round, uniformly sized puffed cereal pieces, a cross-shaped die opening creates uniformly sized, cross-shaped cereal pieces, etc. However, variety in at least the size and shape between various cereal pieces of a single cereal product can be appealing. As can be readily imagined, forming non-uniform cereal pieces from a common cereal dough can be accomplished by employing distinct die opening configurations in the die. For instance, employing a die with six die openings, each having a different configuration, can result in the production of an overall cereal product including six distinct sets of cereal pieces, with each set of cereal pieces having generally uniform, size and shape characteristics which are common among the specific set of cereal pieces but distinct from the other sets of cereal pieces. Still, providing variety in this manner is still limited such that it would be beneficial to provide for the product of cereal pieces through an extrusion process, wherein the resulting cereal pieces are irregular and random in size and shape without the need to employ distinctly configured die openings.

### SUMMARY OF THE INVENTION

A plant protein-based cereal dough directly expands upon extrusion through a die, is cut and then dried in creating irregular and random sized and shaped, puffed cereal pieces. More particularly, puffed cereal pieces which are random and irregular in size and shape relative to each other are produced by forming a plant protein-based cereal dough in a cooking extruder, directly expanding the cereal dough upon exiting a die, cutting the cereal dough directly adjacent the die into extrudate pieces, and drying the extrudate pieces in creating random and irregular sized and shaped, puffed cereal pieces. The plant protein-based cereal dough has a density of about 100-150 g/100 in³ and includes about 30-60% plant protein by weight. Particularly preferred embodiments employ soy protein isolate as the plant protein, either alone or, more preferably, in combination with another plant protein source, such as grains.

Additional objects, features and advantages of the invention will become more fully apparent upon consideration of the following detailed description of the invention when taken in conjunction with the drawings wherein like reference numerals refer to corresponding parts in the several views.

### BRIEF DESCRIPTION OF THE DRAWINGS

FIG. 1 is a perspective view of a bowl of cereal including cereal pieces made in accordance with the invention.

FIG. 2 is a schematic process flow diagram of one embodiment of the method of making the cereal pieces shown in FIG. 1.

FIG. 3 is an enlarged partial view of an extruder die employed in the process represented in FIG. 2.

FIGS. 4A, 4B and 4C illustrate different dies employable in the invention.

FIGS. 5A and 5B illustrate cereal pieces made within density parameters of the invention and cereal pieces not made under the invention, respectively, with the die of FIG. 4A.

FIGS. 6A and 6B illustrate cereal pieces made within density parameters of the invention and cereal pieces not made under the invention, respectively, with the die of FIG. 4B.

FIGS. 7A and 7B illustrate cereal pieces made within density parameters of the invention and cereal pieces not made under the invention, respectively, with the die of FIG. 4C.

FIG. 8 illustrates puffed cereal pieces made with the same die employed in connection with FIG. 3, but without the plant protein-based cereal dough of the invention.

### DETAILED DESCRIPTION OF THE INVENTION

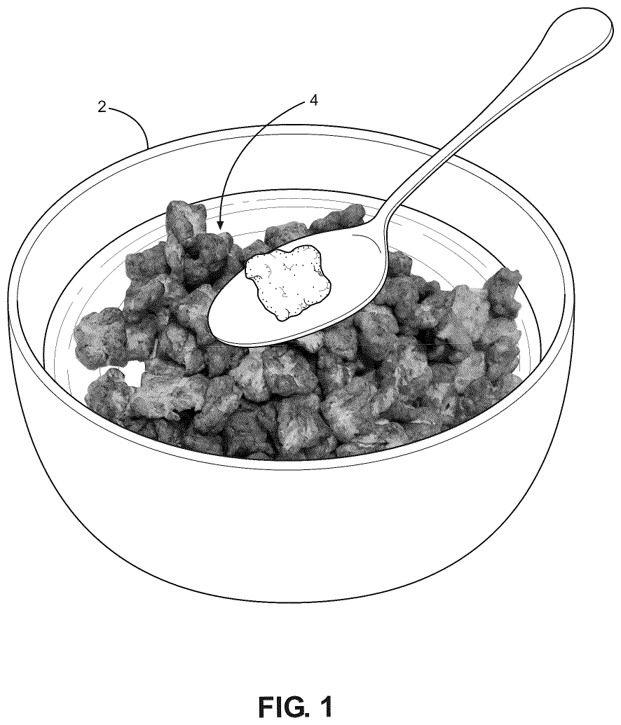

The present invention relates to forming extruded, cut and puffed cereal pieces, which are irregular and random in size and shape, from a plant protein-based, cooked cereal dough, to a finished dried puffed RTE cereal finished product prepared therefrom and to a method for the preparation of the cereal pieces. With initial reference to FIG. 1, a bowl 2 containing irregular and random sized and shaped puffed cereal pieces, made from extruding, direct expanding, cutting and drying a plant protein-based cereal dough in accordance with the invention, are generally indicated at 4. The composition of cereal pieces 4, as well as the method for their preparation and use, are described in detail below. Throughout the specification and claims, unless otherwise specified, percentages are by weight, the term “about” alters a value by 10% and the term “approximately” varies the value by 5%. Understanding random sizes and shaped puffed cereal pieces is considered to be quite clear, while “irregular” in accordance with the invention will be fully apparent from the discussion below in combination with the drawings, but can be broadly qualified as not round or spherical, rather having a roundness range of 0-0.55. As used herein, roundness is a measurement of proximity to a circle, ranging from 0 to 1, with 1 being perfectly circular. Roundness is measured herein by 3D dynamic particle analysis using a Camsizer 3D particle analyzer (Microtrac MRB, Hann, Germany). To measure roundness, a sample of extruded pieces is placed in a 60 mm wide vibratory tray that feeds pieces to the particle analyzer one at a time. Images with a volume of less than 100 mm³ are removed to exclude dust and particulates. Average roundness is determined based on 200 g of each sample. Roundness is calculated using the formula of D_{A}²/MaxDis², where D_{A} is the area equivalent diameter in microns and MaxDis is the maximum distance in microns.

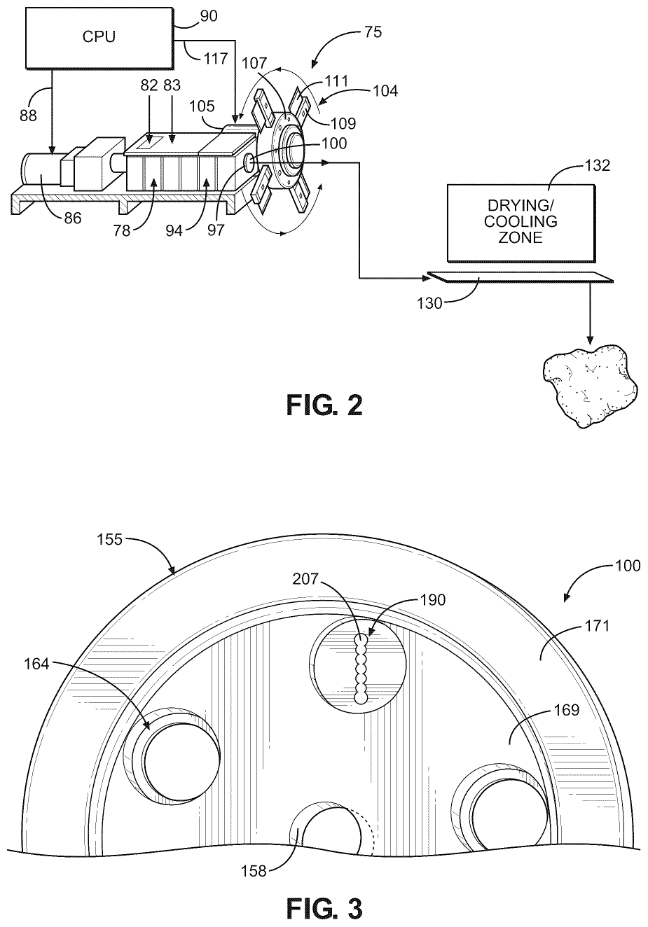

With reference to FIG. 2, an apparatus and method for making cereal pieces 4 will now be described. As shown, apparatus 75 includes a cooking extruder 78 into which various, generally dry cereal ingredients are supplied at 82 to form a cooked cercal dough. Although it should be noted that a wide range of other cereal ingredients suitable for cooking and extrusion can be employed, important to the invention is the introduction of one or more plant protein ingredients, particularly a soy protein isolate, at 82 and water at a downstream barrel or location, generically designated 83, which can include one or more side or bottom liquid injection ports (not shown). As will detailed more fully below, the use of a plant protein ingredient having at least a specified plant protein content as the base constituent in combination with establishing a requisite cereal dough moisture level with the controlled introduction of water at 83 produces an extrudate with a desired density enabling, upon extrusion, expansion, cutting and drying, surprisingly results in achieving individual puffed cercal pieces 4 having irregular and random shapes and sizes. Although not shown, cooking extruder 78 can be defined by an Archimedes-type single or, preferably, twin screw extruder which is driven by a motor 86 linked through a communication line 88 to a CPU 90. Both single and twin screw extruders are widely known in the art and can advantageously be used to enable a continuous process for manufacturing purposes.

As illustrated, cooking extruder 78 includes various barrels generally ranging in number from 4 to 9, with a lattermost, cooking barrel section, preferably formed from multiple barrels and heated electrically or with oil, being generally indicated at 94 having an outlet 97 at which is provided an extrusion die 100. Mounted directly adjacent cooking barrel section 94 is a cutter unit 104 including a hub 107 which rotatably supports a plurality of cutter arms 109 having secured thereto respective blades 111. Cutter unit 104 includes a motor 105 for driving rotatable cutter arms 109, with motor 105 being linked through a communication line 117 to CPU 90. Certainly, various types and configurations for cutter unit 104 can be employed, with the embodiment shown having blades 111 directly adjacent or juxtapose a face of die 100.

In operation, ingredients 82 and 83 are introduced into cooking extruder 78 of apparatus 75 and blended to form a cereal mix which is cooked and mechanically worked to form a cereal dough. Through activation of motor 86, the cereal dough is directed through cooking barrel section 94 and through extrusion die 100 in the form of an extrudate, such as in a rope or ribbon form, which is instantly subjected to direct expansion. Timed with the ejection of the extrudate, cutter arms 109 of cutter unit 104 rotate so as to cut the extrudate directly adjacent outlet 97 of die 100, resulting in extrudate pieces which are subsequently delivered onto a conveyor 130 and directed through a drying/cooling zone 132 (e.g., dried to about 3-5% moisture) in producing puffed cereal pieces 4. If desired, other fabrication steps can be added, such as a step of applying a topical coating on cereal pieces 4. For instance, in the preparation of a breakfast cereal, the topical coating can include a sugar coating, however a no-sugar or low sugar coating can be employed. In a particular embodiment of the invention, a no-sugar coating containing erythritol is applied. Most importantly, in connection with the invention, it has been surprisingly found that each of the plant protein-based extrudate pieces 4 expand uniquely, with an overall random and irregular direct expansion and puffing occurring across the various pieces and resulting in, after drying/cooling zone 132, cereal pieces 4 having irregular and random sizes and shapes, even when employing uniformly configured die openings for die 100 as will now be detailed with specific reference to FIG. 3.

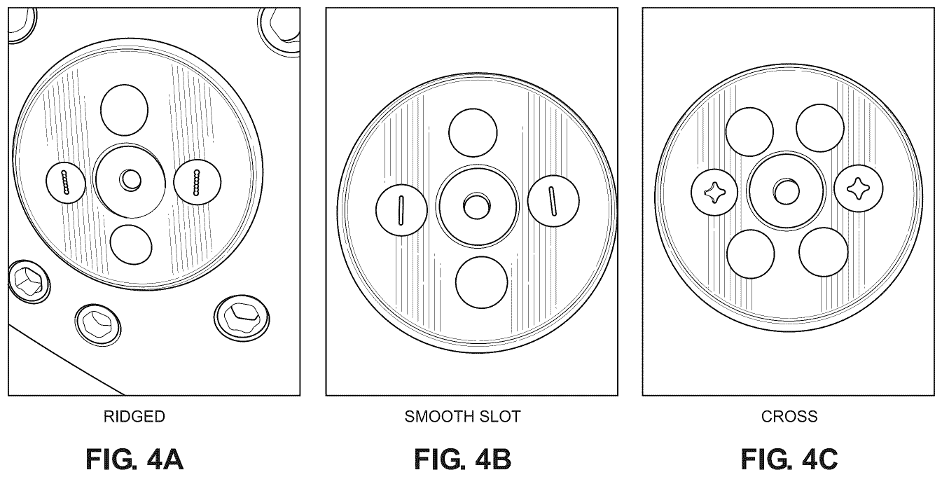

As shown in FIG. 3, extrusion die 100 includes a die plate or head 155 having a central opening 158, such as for fitting or holding a distribution cone, and a plurality of spaced extrudate ports 164. More specifically, die head 155 includes a main body 169 containing the plurality of spaced extrudate ports 164 located radial inward of a peripheral flange portion 171. Each of the plurality of spaced extrudate ports 164 is configured to receive a die insert 190 having an extrudate or die opening 207. In the embodiment shown, only one die insert 190 is shown mounted but it is to be understood that each extrudate port 164 would be provided with an identical die insert 190 having a common die opening 207. Of course, die inserts 190 need not actually be employed as die openings 207 could be directly manufactured into die head 155. In the illustrated embodiment, die opening 207 exhibits a slotted arrangement made up of a series of interconnected circular openings, with the outermost or terminal openings being slightly larger in diameter than the intermediate openings (elements not separately labeled). However, as exemplified further below with reference to FIGS. 4A-4C, it should be understood that a wide range of die opening configurations could be employed in accordance with the invention while still resulting in puffed cereal pieces which are randomly and irregularly sized and shaped from each other. As evidenced by comparing the configuration of die opening 207 and the shapes of the various cereal pieces 4 shown in FIG. 1 which were made using a series of die inserts 190 each with a die opening 207, the final shape of cereal pieces 4 does not have a direct correlation to the die opening design. In fact, the illustrated configuration of die opening 207 was originally selected in looking to create a rectangular shaped final product piece, but it soon became evident that the plant protein-based cereal dough directly expanded in an irregular and unexpected way to form puffed cereal pieces 4 with a common die opening configuration.

As indicated above, the use of one or more plant protein ingredients having at least a specified plant protein content as the base constituent in combination with establishing a requisite cereal dough moisture level with the controlled introduction of water 83 produces an extrudate with a desired density enabling, upon extrusion, expansion, cutting and drying, surprisingly results in achieving individual puffed cereal pieces 4 having irregular and random shapes and sizes. Actually, upon startup of apparatus 75, the water content is purposely raised higher to basically prime the apparatus, with the resulting extrudate generally holding its shape. However, upon reducing the water content at 83, the direct expanded/puffed product of the invention results. More specifically, under the invention, the plant-based protein content is established between about 30-60%, with approximately 45-50% being preferred. This rather high protein content is needed as it has been found that a lower protein content results in cereal pieces having more consistent shapes. In addition, as also indicated above, the density of the cereal dough is important, with a desired density being regulated through the controlled introduction of water at 83 to be within the range of about 100-150 g/100 in³, preferably about 105-130 g/100 in³. This rather low density is needed as it has been found that increasing density (by increasing the amount of water employed) also results in cereal pieces having quite consistent shapes. The water level can be regulated thru CPU 90 to establish and maintain the desired density and depends on various factors, including dough formulation, process conditions and die design. If the appropriate density is not maintained, even adjusting the protein level will not result in the desired production of random and irregular sized and shaped, puffed cereal pieces 4. In general terms, high water levels result in a higher density and less puffing, while lower water levels can produce lower density and more puffing. Within cooking extruder 78, a moisture content of the plant protein-based cereal dough will range from about 20-35% (wet basis).

In addition to the plant-based protein content and the density, the kind of plant protein has also been found to be important. As indicated above, a preferred plant protein is soy protein isolate employed along or in combination with one or more other plant proteins. By way of example, the plant-based protein can be derived from seeds (canola), legumes (peas, beans, chickpea, lentil) or grains (wheat, corn). It has been found that important main characteristics of the plant-based protein ingredient(s) in achieving the invention include at least solubility and water binding properties. By way of example, relevant properties of three tested soy protein isolates are listed in Table 1 presented below. From Table 1, it should be noted that Samples A and B were successfully employed in producing random and irregular sized and shaped, puffed cereal pieces in accordance with the invention, while Sample C did not possess the requisite characteristics such that the results were unsuccessful. Actually, as reflected in Table 1, each successful protein has over 85% protein which has a medium to high molecular weight, a medium to high water solubility at pH 7, a high water binding capacity and a high oil binding capacity. In addition, such a protein potentially has a high emulsification stability.

TABLE 1

| | | | | | | | Protein | | | | | |
|---|---|---|---|---|---|---|---|---|---|---|---|---|
| | | | | | | | Solubility pH | | | | | |
| | | | | | | | ranges (>70% high | | | | | |
| | | | | | | | solubility, 30-70% | | | | | |
| | | | | | | Protein | Mid solubility, <30 | | Water Holding | | Oil Holding | |
| | | | | | | content | low solubility) | | Capacity # | | Capacity # | |
| | | | | | | (N × | | Low/ | | Low/ | | Low/ |
| | | | | Processing- | | 6.25) | % at | Mid/ | g water/ | Mid/ | g oil/ | Mid/ |
| Sample | Category | Source | PDCAAS | Conditions | Drying | % | pH 7 | High | g sample | High | g sample | High |
| A | Legume | Soy | 0.93 | Alcohol | Spray Dry | 87.4 | 30 | mid | 4.69 | high | 2.11 | high |
| | | | | Extracted | | | | | | | | |
| B | Legume | Soy | 0.95 | Alcohol | Spray dry | 91 | 35 | mid | 6.1 | high | 1.5 | high |
| | | | | Extration | | | | | | | | |
| C | Legume | Soy | 0.91 | Alcohol | Spray Dry | 92.8 | 7 | Low | 2.2 | med | 1 | med |
| | | | | extracted | | | | | | | | |

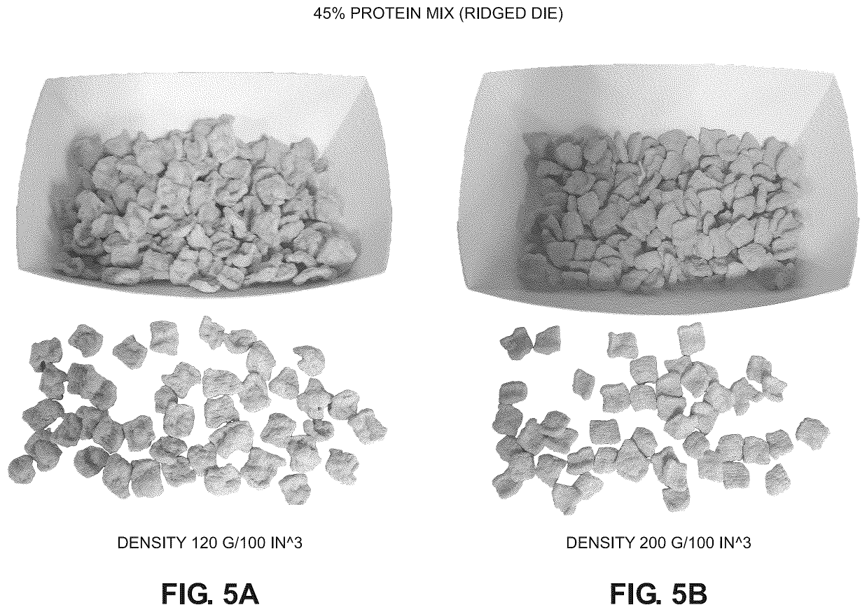

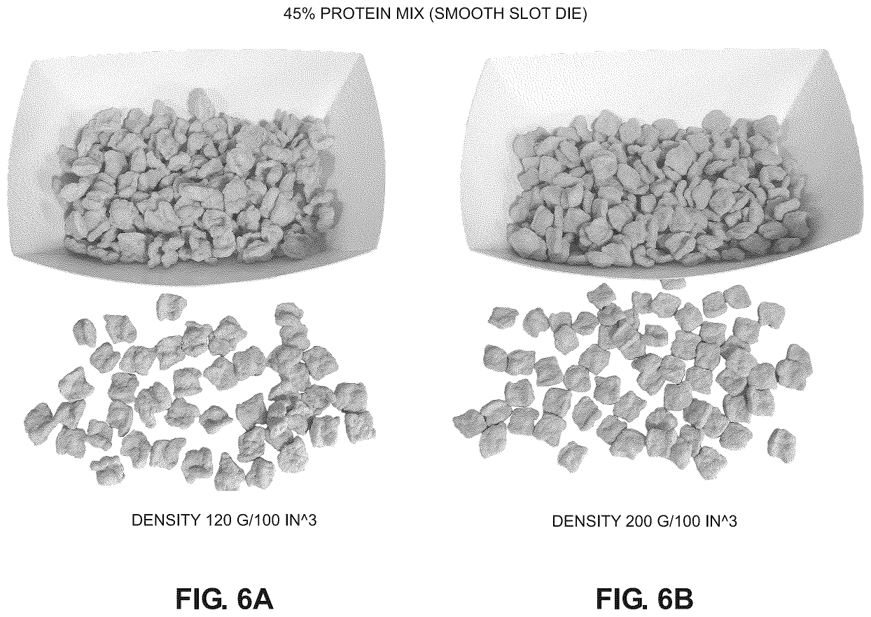

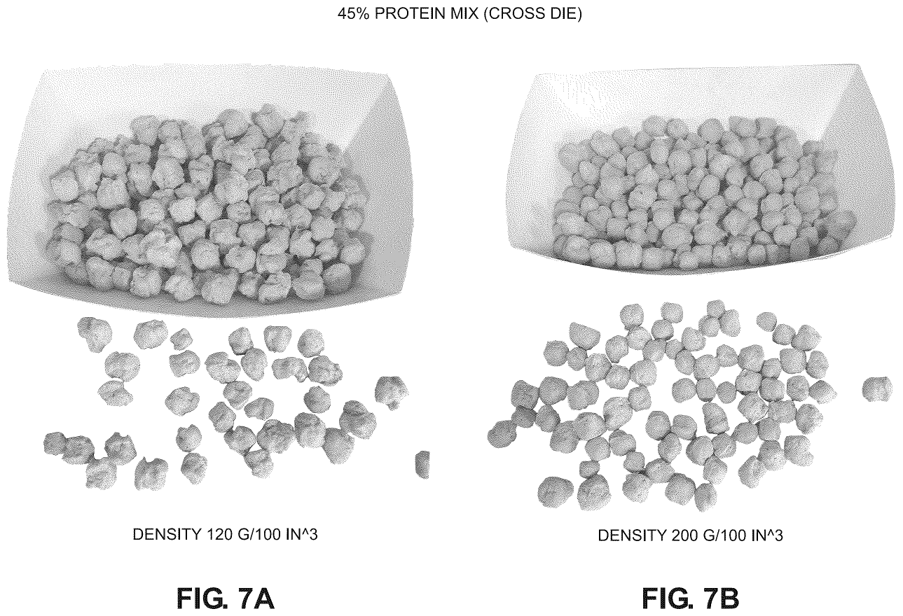

As indicated above, a wide range of die opening configurations could be employed in accordance with the invention while still resulting in puffed cereal pieces which are randomly and irregularly sized and shaped from each other. By way of certain tested examples, FIG. 4A shows a ridged die design having a slotted die opening corresponding to opening 207; FIG. 4B depicts a smooth slotted die opening (basically a slot similar to opening 207 but not made up of the interconnected circles); and FIG. 4C illustrates a cross-shaped die opening configuration. FIGS. 5-7 are presented to emphasize the importance of the density in connection with the invention. More specifically, FIG. 5A illustrates puffed cereal products produced in accordance with the invention with the ridged die design of FIG. 4A, i.e., a die having openings 207, and a cereal dough including 45% protein and a density of 120 g/100 in³, and FIG. 5B shows cereal products having substantially similar sizes and shapes to each other produced with the same die and cereal dough protein content, but with a dough density of 200 g/100 in³. In a similar manner, FIGS. 6A and 6B illustrate puffed cereal products made with the smooth slotted die openings of FIG. 4B, while FIGS. 7A and 7B show puffed cereal products made with the cross-shaped die openings of FIG. 4C. Again, it should be noted how the density employed in making the cereal pieces shown in FIGS. 6A and 7A are in accordance with the present invention, while the cereal pieces shown in FIGS. 5B, 6B and 7B are not.

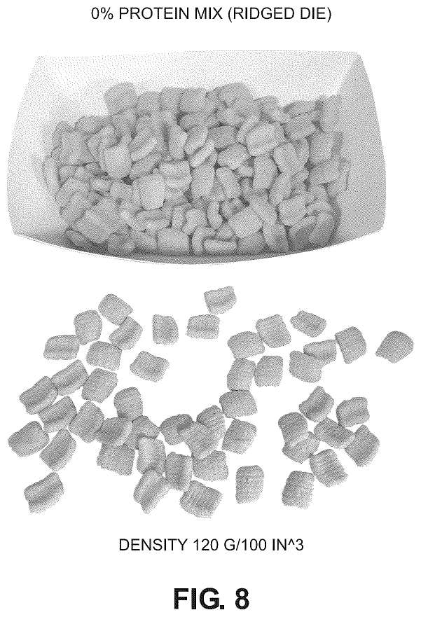

FIG. 8 is presented to emphasize the importance of the use of a plant protein-based cereal dough in connection with the invention. That is, FIG. 8 illustrates how puffed cereal pieces made with the same die employed in connection with FIG. 3, i.e., a die with openings 207, but without use of a plant protein-based cereal dough employed with the invention, are substantially identical in shape and size, even at a desired density. Actually, even using plant protein-based cereal dough with low protein levels, i.e., protein levels below 30%, failed to achieve the invention, regardless of die shape or density employed. For a better understanding, Table 2 presented below sets forth the composition of the cereal dough “45% protein mix” of FIG. 5A versus the “0% protein mix” of FIG. 8.

TABLE 2

| | 45% Protein | 0% Protein |
|---|---|---|
| Soy Protein Isolate #29 | 45.44 | 0.00 |
| CornCones | 26.30 | 26.30 |
| Whole grain corn flour | 16.18 | 61.62 |
| Corn bran | 10.00 | 10.00 |
| Salt | 1.300 | 1.300 |
| Sodium Bicarbonate | 0.100 | 0.100 |
| Calcium Carbonate | 0.500 | 0.500 |
| RL Blend | 0.180 | 0.180 |
| | 100.00 | 100.00 |

As indicated above, certain embodiments of the invention employ a combination of plant-based protein sources, with certain preferred embodiments employing a combination of soy protein isolate and one or more grains, such as in the specific example represented in Table 2. However, a combination of one or more grain ingredients containing starch and another protein ingredient like soy protein isolate presents some significant additional hurdles in connection with achieving the overall invention, basically because starch-based ingredients from grain need directionally different processing conditions than other protein ingredients. More specifically, starch needs to be properly cooked and gelatinized, requiring high temperatures, high shear and low water, while other plant-based proteins including soy protein isolate need the opposite, i.e., lower temperatures to prevent burning in the extruder and especially in the die, lower shear as, if over-sheared, they will not develop the same functionality and do not contribute to puffing, and higher moisture to assure proper hydration to enable the development needed for the requisite functionality. In connection with developing these combination plant protein embodiments, if insufficient heat, shear and residence time in the extruder was applied, the starch was not cooked out enough and then could not provide necessary binding and expansion characteristics such that the resulting products were not properly puffed and did not have the desired density. In particular, under these insufficient operating parameters, the product did not hold together and appeared shredded. However, if the temperature was too high, the product would start burning in the die, eventually plugging the die openings. Although seeking to employ such a combination of plant protein sources may be counterintuitive based on the numerous issues involved, with continued testing, optimum conditions were determined which achieved gelatinization of the starch to provide the requisite binding and puffing, resulting in a cohesive product, while avoiding burn issues.

For the sake of completeness, specific optimizing parameters in connection with this cereal product containing both corn and soy protein isolate include: a die temperature in the range of 280-350° F.; extruder cooking zone barrel temperatures (particularly the last 2-4 barrels) of 270-305° F.; a die flow rate in the order of 70-170 lbs/hr/die opening, preferably about 80-110 lbs/hr/die opening; a die pressure in the range of 700-1700 PSI, more preferably 700-1300 PSI; and a residence time in the range of about 20-45 seconds.

The finished cereal pieces 4 of the invention are typically packaged in a sealed bag which can be arranged inside an outer carton to establish a box of cereal. In the bag or box, cereal pieces 4 can be packaged alone or in combination with other cereal particulates or pieces. Certainly, cereal pieces 4 can be added to a bowl 2, milk added and then consumed in a traditional fashion. However, cereal pieces 4 are also suitable as a standalone snack or as an additive to a packaged snack mix including, for instance, other cereal pieces, pretzels, dried fruit, chocolate pieces, nuts and the like. In any case, it should be readily apparent that the invention has been described with reference to certain embodiments of the invention but various changes and/or modifications can be made to the invention without departing from the spirit thereof.

1. A method of making cereal pieces comprising:
forming a plant protein-based cereal dough in an extruder, with the cereal dough having a plant protein level of at least 30% by weight;
extruding the cereal dough from a geometric opening of a die;
directly expanding the cereal dough upon exiting the die;
cutting the cereal dough directly adjacent the die into extrudate pieces; and
drying the extrudate pieces in creating random sized and shaped, puffed cereal pieces having a roundness range of 0-0.55.

2. The method of claim 1, wherein the cereal dough is extruded through a plurality of spaced geometric openings provided about a face portion of the die, with each of plurality of spaced geometric openings having a common die opening configuration while still resulting in the random sized and shaped, puffed cereal pieces.

3. The method of claim 2, wherein the cereal dough includes about 30-60% plant protein by weight.

4. The method of claim 3, wherein the cereal dough includes approximately 45-50% plant protein by weight.

5. The method of claim 2, wherein the cereal dough is extruded under the conditions of:
a die temperature in the range of 280-350° F.;
extruder cooking zone barrel temperatures between 270-305° F.;
a die flow rate in the order of 70-170 lbs/hr/die opening;
a die pressure in the range of 700-1700 PSI; and
a residence time in the range of about 20-45 seconds.

6. The method of claim 1, wherein the plant protein includes at least 85% protein having a medium to high molecular weight, medium to high water solubility at pH 7, a high water binding capacity and a high oil binding capacity.

7. The method of claim 1, wherein the plant protein is soy protein isolate.

8. The method of claim 1, wherein the plant protein is derived from seeds, legumes or grains.

9. The method of claim 7, wherein the plant protein is derived from a combination of soy protein isolate and one or more types of grains.

10. The method of claim 1, wherein forming the plant protein-based cereal dough includes forming the plant protein-based cereal dough with a density of about 100-150 g/100 in³.

11. The method of claim 10, wherein the density is approximately 105-130 g/100 in³.

12. The method of claim 2, wherein extruding the cereal dough from the plurality of spaced geometric openings of the die includes extruding the cereal dough through slotted openings having ridges.

13. The method of claim 2, wherein extruding the cereal dough from the plurality of spaced geometric openings of the die includes extruding the cereal dough through smooth slotted openings.

14. The method of claim 2, wherein extruding the cereal dough from the plurality of spaced geometric openings of the die includes extruding the cereal dough through cross-shaped openings.

15. The method of claim 1, further comprising coating the puffed cereal pieces with a sugar, no-sugar or low sugar coating.

16. A plurality of puffed cereal pieces which are produced by the method of claim 1, said plurality of puffed cereal pieces being sealed in a bag.

17. A bag or box of cereal including puffed cereal pieces which are in a size and shape produced by the method of claim 1.

18. The bag or box of cereal of claim 17, wherein the plant protein is derived from seeds, legumes or grains.

19. The bag or box of cereal of claim 18, wherein the plant protein is derived from a combination of soy protein isolate and one or more types of grains.
